(19) United States
(12) Patent Application Publication
(10) Pub. No.: US 2019/0285736 A1
(43) Pub. Date: Sep. 19, 2019

(54) ULTRASOUND RANGING DEVICE, SYSTEM AND METHOD

(71) Applicant: Quanta Computer Inc., Taoyuan City (TW)

(72) Inventors: Ming-Hong NI, Taoyuan City (TW); Chien-Hung LIU, Taoyuan City (TW)

(21) Appl. No.: 16/137,588

(22) Filed: Sep. 21, 2018

(30) Foreign Application Priority Data
Mar. 19, 2018 (TW) 107109249

(51) Int. Cl. G01S 7/52; G01S 15/08

(52) U.S. Cl. CPC G01S 7/52004; G01S 15/08

(57) ABSTRACT

An ultrasound ranging device is provided. The ultrasound ranging device includes an ultrasound transmitter, an ultrasound receiver, a light sensor and a processor. The ultrasound transmitter transmits an ultrasonic signal. The ultrasound receiver receives a reflected signal which is generated when the ultrasonic signal meets an obstacle. The light sensor receives light-source data from an external light-source device. The processor is coupled to the light sensor to obtain the light-source data from the light sensor. The processor performs a time calibration according to the light-source data. In addition, after the time calibration, according to barcode information corresponding to the processor, the processor determines the time interval in which the ultrasound transmitter transmits the ultrasonic signal.

### CROSS REFERENCE TO RELATED APPLICATIONS

This application claims priority of TW Patent Application No. 107109249 filed on Mar. 19, 2018, the entirety of which is incorporated by reference herein.

### BACKGROUND OF THE INVENTION

### Field of the Invention

The invention generally relates to ultrasound ranging technology, and more particularly, to ultrasound ranging technology in which a plurality of ultrasound ranging devices are first calibrated using light-source data and then ultrasound ranging is performed.

### Description of the Related Art

As technology progresses, ultrasound is widely applied in different fields, such as distance measurement, medicine, fish detection, vehicle parking sensors, and so on.

In ultrasound ranging, an ultrasound ranging device is used to transmit an ultrasonic signal and to receive a reflected signal which is generated when the ultrasonic signal meets an obstacle, and this reflected signal can be used to help calculate the distance to the obstacle. However, when a plurality of ultrasound ranging devices perform ultrasound ranging at the same time, such as when a plurality of unmanned aerial vehicles need to perform an aerial exhibition together, the ultrasound ranging devices may interfere with each other, and as a result, a collision may occur.

### BRIEF SUMMARY OF THE INVENTION

An ultrasound ranging device, system and method are provided to overcome the problems mentioned above.

An embodiment of the invention provides an ultrasound ranging device. The ultrasound ranging device comprises an ultrasound transmitter, an ultrasound receiver, a light sensor, and a processor. The ultrasound transmitter transmits an ultrasonic signal. The ultrasound receiver receives a reflected signal which is generated when the ultrasonic signal meets an obstacle. The light sensor receives light-source data from an external light-source device. The processor is coupled to the light sensor to obtain the light-source data from the light sensor. The processor performs a time calibration according to the light-source data. In addition, after the time calibration, according to barcode information corresponding to the processor, the processor determines the time interval in which the ultrasound transmitter transmits the ultrasonic signal.

An embodiment of the invention provides an ultrasound ranging system. The ultrasound ranging system comprises an external light-source device and a plurality of electronic devices. The external light-source device generates light-source data. Each of the electronic devices comprises an ultrasound ranging device. Each ultrasound ranging device comprises an ultrasound transmitter, an ultrasound receiver, a light sensor and a processor. The ultrasound transmitter transmits an ultrasonic signal. The ultrasound receiver receives a reflected signal which is generated when the ultrasonic signal meets an obstacle. The light sensor receives the light-source data. The processor is coupled to the light sensor to obtain the light-source data from the light sensor. The processor performs a time calibration according to the light-source data. In addition, after the time calibration, according to barcode information corresponding to the processor, the processor determines the time interval in which the ultrasound transmitter transmits the ultrasonic signal. Each ultrasound ranging device of each electronic device corresponds to different barcode information and time intervals.

An embodiment of the invention provides an ultrasound ranging method. The ultrasound ranging method is applied to an ultrasound ranging device. The ultrasound ranging method comprises the steps of receiving light-source data from an external light-source device; performing time calibration using the light-source data; according to barcode information corresponding to a processor of the ultrasound ranging device, determining a time interval in which an ultrasound transmitter of the ultrasound ranging device transmits the ultrasonic signal; and performing ultrasound ranging in the time interval when a control signal is received from a control device.

Other aspects and features of the invention will become apparent to those with ordinary skill in the art upon review of the following descriptions of specific embodiments of methods and devices.

### BRIEF DESCRIPTION OF THE DRAWINGS

The invention will become more fully understood by referring to the following detailed description with reference to the accompanying drawings, wherein:

FIG. 1 is a block diagram of an ultrasound ranging system 100 according to an embodiment of the invention;

FIG. 2 is a block diagram illustrating an electronic device 120 according to an embodiment of the invention;

FIG. 3A is a block diagram illustrating an ultrasound ranging device 121 according to an embodiment of the invention;

FIG. 3B is a schematic diagram illustrating an ultrasound ranging device 121 according to an embodiment of the invention;

FIG. 4 is a schematic diagram illustrating the time interval according to an embodiment of the invention;

FIG. 5A is a circuit diagram illustrating an ultrasound ranging device 121 according to an embodiment of the invention;

FIG. 5B is a circuit diagram illustrating a control device 122 according to an embodiment of the invention; and

FIG. 6 is a flow chart 600 illustrating an ultrasound ranging method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

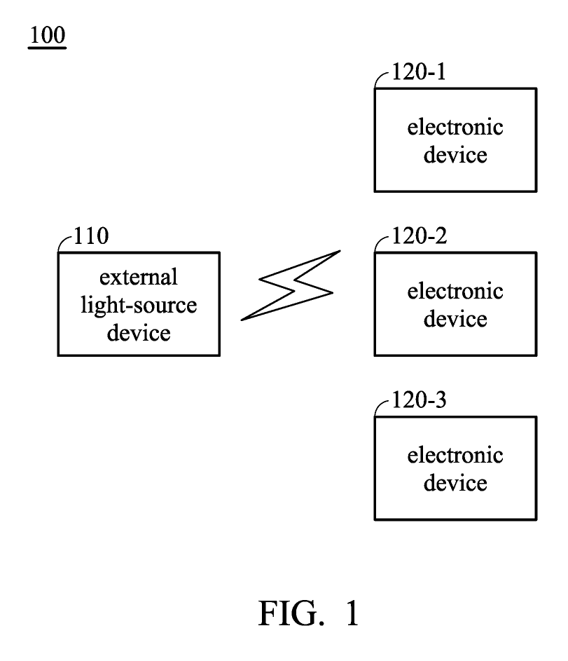

FIG. 1 is a block diagram of an ultrasound ranging system 100 according to an embodiment of the invention. As shown in FIG. 1, the ultrasound ranging system 100 may comprise an external light-source device 110 and a plurality of electronic devices 120-1˜120-3. Note that, FIG. 1 presents a simplified block diagram in which only the elements relevant to the invention are shown. However, the invention should not be limited to what is shown in FIG. 1. The ultrasound ranging system 100 also can comprise different number of electronic devices.

In an embodiment of the invention, the external light-source device 110 may generate light-source data, and transmit the light-source data to the electronic devices 120-1˜120-3 through optical communication schemes (e.g. infra-red ray, but the invention should not be limited to thereto). According to an embodiment of the invention, the light-source data may comprise time packet. The electronic devices 120-1˜120-3 may perform a time calibration using the time packet to synchronize the internal clocks of the electronic devices 120-1˜120-3 with each other.

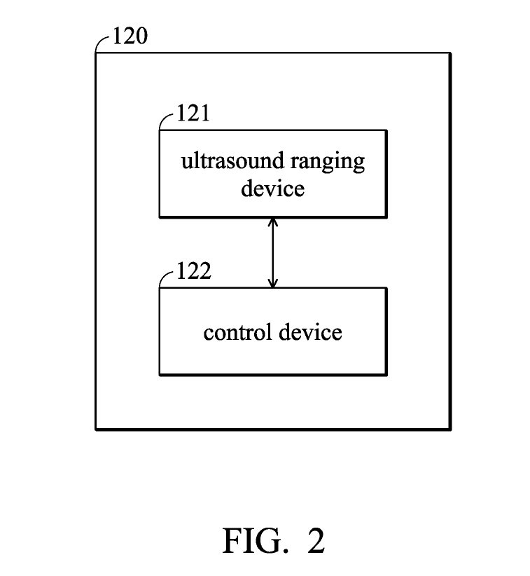

FIG. 2 is a block diagram illustrating an electronic device 120 according to an embodiment of the invention. The electronic device 120 can be applied in the electronic devices 120-1˜120-3 of FIG. 1. According to the embodiments of the invention, the electronic device 120 may be an unmanned aerial vehicle, a robot, and so on. As shown in FIG. 2. The electronic device 120 may comprise an ultrasound ranging device 121 and a control device 122. Note that, FIG. 2 presents a simplified block diagram for illustrating the embodiment of the invention conveniently. However, the invention should not be limited to what is shown in FIG. 2. The electronic device 120 may comprise other elements.

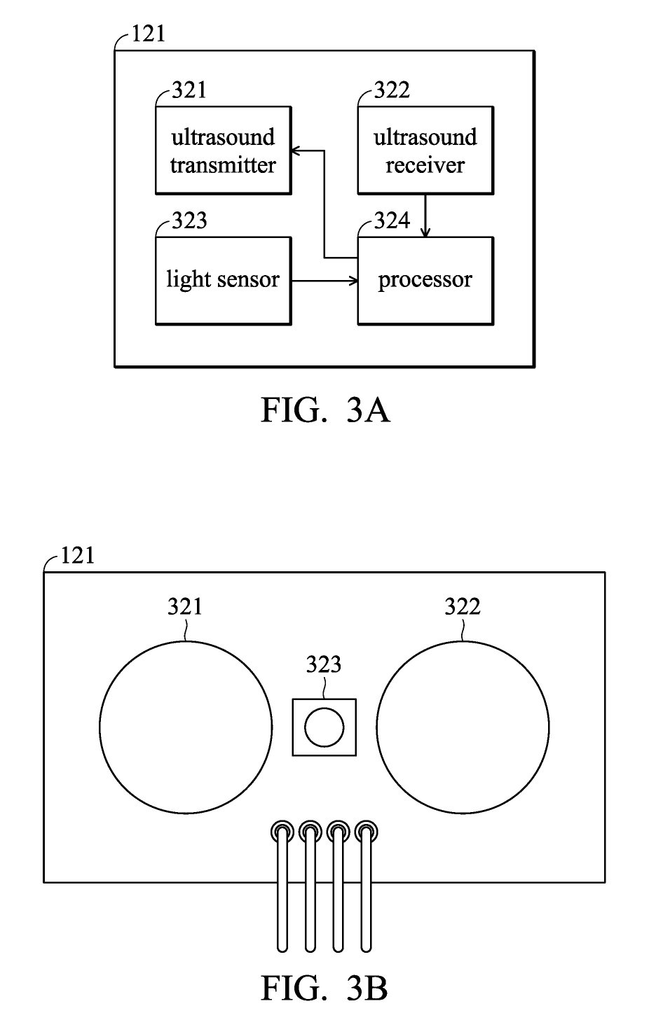

According to an embodiment of the invention, the ultrasound ranging device 121 may receive the light-source data from the external light-source device 110 to perform the time calibration. Furthermore, the ultrasound ranging device 121 may receive the control signals from the control device 122, and perform the ultrasound ranging according to the control signals from the control device 122. Details are illustrated through FIG. 3 below.

FIG. 3A is a block diagram illustrating an ultrasound ranging device 121 according to an embodiment of the invention. As shown in FIG. 3A, the ultrasound ranging device 121 may comprise an ultrasound transmitter 321, an ultrasound receiver 322, a light sensor 323 and a processor 324. Note that FIG. 3A presents a simplified block diagram for conveniently illustrating the embodiment of the invention. However, the invention should not be limited to what is shown in FIG. 3A. FIG. 3B is a schematic diagram illustrating an ultrasound ranging device 121 according to an embodiment of the invention.

According to an embodiment of the invention, the ultrasound transmitter 321 may transmit an ultrasonic signal, and the ultrasound receiver 322 may receive a reflected signal which is generated (reflected) when the ultrasonic signal transmitted by the ultrasound transmitter 321 meets the obstacle. According to an embodiment of the invention, the light sensor 323 may be an infra-red ray sensor, but the invention should not be limited thereto. According to an embodiment of the invention, the processor 324 may be a microcontroller unit (MCU).

According to an embodiment of the invention, when a plurality of electronic devices 120 (e.g. electronic devices 120-1˜120-3) need to perform operations together (i.e. the electronic devices 120 may perform ultrasound ranging at the same time), the external light-source device 110 may generate light-source data, and transmit the light-source data to each electronic device 120 through an optical communication scheme.

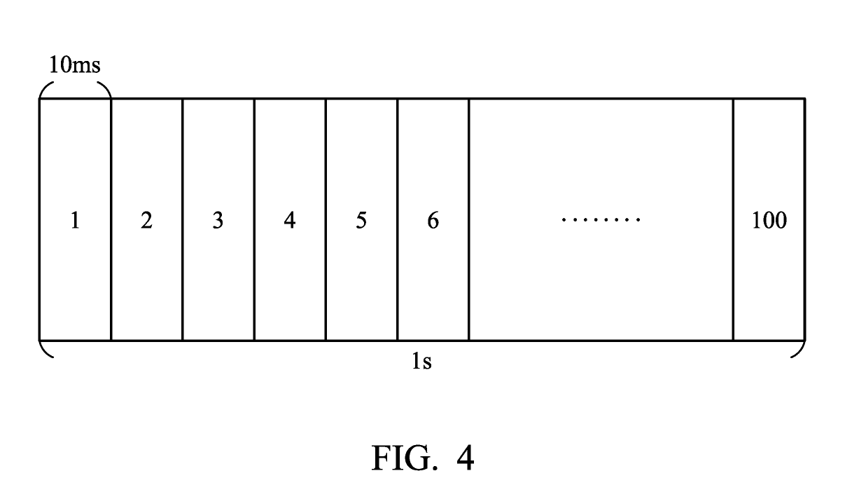

After the light sensor 323 of each electronic device 120 receives the light-source data, the light sensor 323 may transform the light-source data from the optical communication signal to the voltage signal, and then transmits the transformed light-source data to the processor 324. The processor 324 may perform a time calibration using the time packet of the light-source data. After the time calibration, the internal clock of the processor 324 of each electronic device will be synchronized with each other. Furthermore, after the time calibration, according to barcode information corresponding to the processor 324, the processor 324 may determine the time interval in which the ultrasound transmitter 321 transmits the ultrasonic signal. The barcode information may correspond to a barcode which is stuck on each ultrasound ranging device 121 when the ultrasound ranging device 121 is manufactured. The barcode may be scanned to the firmware of the processor 324. Therefore, each processor 324 of each electronic device 120 may have different barcode information. When the processor 324 may determine a time interval, in which the ultrasound transmitter 321 may transmit the ultrasonic signal, according to its barcode information, the processor may read the barcode information stored in its firmware. Because each processor 324 has different barcode information, the ultrasound ranging device 121 of each electronic device 120 may perform ultrasound ranging in different time interval. FIG. 4 is used as an example to illustrate the time interval below.

FIG. 4 is a schematic diagram illustrating the time interval according to an embodiment of the invention. As shown in FIG. 4, if 10 millisecond (ms) is used as the unit of the time interval, 1 second can be divided into 100 time intervals. If the barcode information corresponding to the processor 324 of the ultrasound ranging device 121 of the electronic device 120-1 is 20071026XXX01, the processor 324 of the electronic device 120-1 may refer to the last two codes of the barcode information to determine that the ultrasound ranging device 121 needs to perform ultrasound ranging in the time interval 1 (0˜10 ms). If the barcode information corresponding to the processor 324 of the ultrasound ranging device 121 of the electronic device 120-2 is 20071026XXX02, the processor 324 of the electronic device 120-2 may refer to the last two codes of the barcode information to determine that the ultrasound ranging device 121 needs to perform ultrasound ranging in the time interval 2 (11˜20 ms). If the barcode information corresponding to the processor 324 of the ultrasound ranging device 121 of the electronic device 120-3 is 20071026XXX05, the processor 324 of the electronic device 120-3 may refer to the last two codes of the barcode information to determine that the ultrasound ranging device 121 needs to perform ultrasound ranging in the time interval 5 (41˜50 ms). Note that the example is merely an embodiment of the invention, but the invention should not be limited thereto. In other embodiments of the invention, a different length also can be used as the unit of the time interval.

When the time calibration of each electronic device 120 is performed, the electronic device 120 may wait for the control signal transmitted by the control device 122. When the processor 324 of each electronic device 120 receives the control signal transmitted by the control device 122, the processor 324 may indicate the ultrasound transmitter 321 to transmit an ultrasonic signal at a fixed frequency (e.g. an ultrasonic signal 10101010 of 40 KHz, but the invention should not be limited thereto) in the time interval corresponding to the processor 324 to perform the ultrasound ranging. When the ultrasound receiver 322 receives a reflected signal which is generated when the ultrasonic signal transmitted by the ultrasound transmitter 321 meets the obstacle, the ultrasound receiver 322 may transform the reflected signal to the voltage signal, and then transmit the voltage signal to the processor 324. The processor 324 may calculate distance based on the roundtrip time of the ultrasonic signal (i.e. (roundtrip time of the ultrasonic signal*sound velocity)/2), and transmit a response signal about the distance to the control device 122.

According to an embodiment of the invention, after the ultrasound transmitter 321 transmits the ultrasonic signal, the processor 324 may start to count time. If the ultrasound receiver 322 does not receive the reflected signal within a default time (e.g. 5 ms), the processor 324 may restart to await a new control signal transmitted by the control device 122.

According to an embodiment of the invention, after the processor 324 receives the reflected signal (which is transformed into a voltage signal by the ultrasound receiver 322) from the ultrasound receiver 322, the processor 324 may first enlarge the reflected signal using an operational amplifier (not shown in figures), and then the processor 324 may compare the voltage value of the enlarged signal with a threshold using a comparator (not shown in figures) to determine whether the voltage value of the enlarged signal is greater than the threshold. If the voltage value of the enlarged signal is greater than the threshold, the processor 324 may calculate distance based on the roundtrip time of the ultrasonic signal, and transmit a response signal about the distance to the control device 122. If the voltage value of the enlarged signal is not greater than the threshold, the processor 324 may restart to wait for a new control signal to be transmitted by the control device 122.

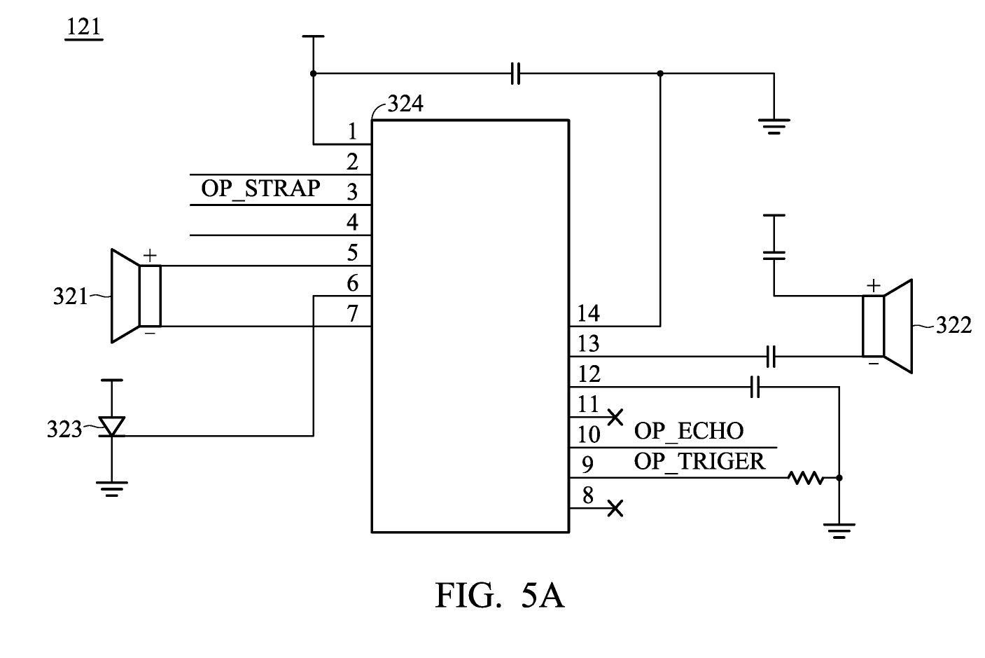

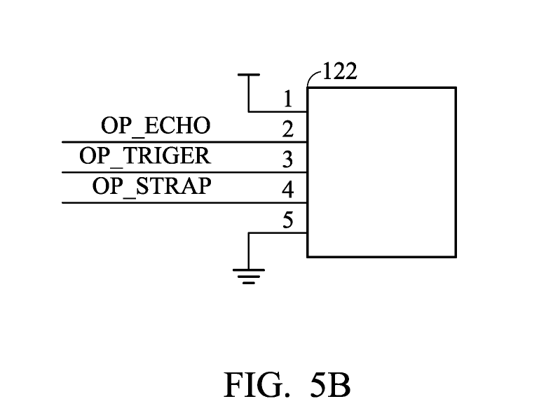

FIG. 5A is a circuit diagram illustrating an ultrasound ranging device 121 according to an embodiment of the invention. FIG. 5B is a circuit diagram illustrating a control device 122 according to an embodiment of the invention. Note that FIGS. 5A and 5B are simplified circuit diagrams illustrating an embodiment of the invention. However, the invention should not be limited to what is shown in FIGS. 5A and 5B. As shown in FIGS. 5A and 5B, the sixth pin of the processor 324 is coupled to the light sensor 323, the fifth and seventh pins of the processor 324 are coupled to the ultrasound transmitter 321, and the twelfth pin of the processor 324 is coupled to the ultrasound receiver 322. In addition, the third pin of the processor 324 is coupled to the fourth pin of the control device 122, the ninth pin of the processor 324 is coupled to the third pin of the control device 122, and the tenth pin of the processor 324 is coupled to the second pin of the control device 122. The control device 122 may transmit a control signal OP_TRIGER to the processor 324 through its third pin to notify the processor 324 to perform the ultrasound ranging. When the processor 324 calculates distance based on the roundtrip time of the ultrasonic signal, the processor 324 may transmit a response signal OP_ECHO about the distance to the control device 122 through its tenth pin to notify the control device 122 about the result of the ultrasound ranging (i.e. the distance).

According to an embodiment of the invention, if only one electronic device 120 is enabled (i.e. the electronic devices 120 does not need to perform ultrasound ranging at the same time), the processor may directly wait for the control signal transmitted by the control device 122 to perform the ultrasound ranging.

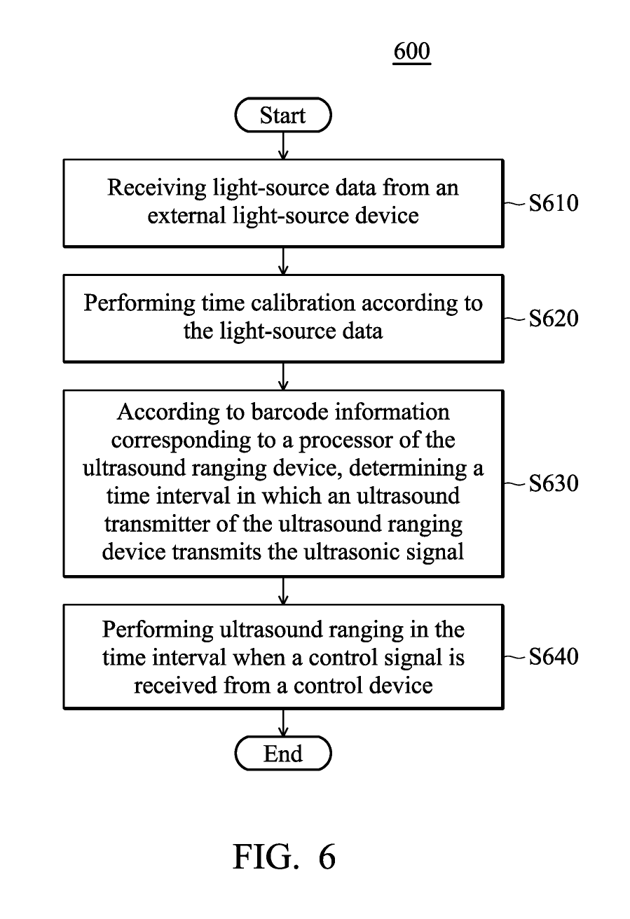

FIG. 6 is a flow chart 600 illustrating an ultrasound ranging method according to an embodiment of the invention. The ultrasound ranging method is applied to the ultrasound ranging system 100 and the ultrasound ranging device 121. As shown in FIG. 6, in step S610, an ultrasound ranging device may receive light-source data from an external light-source device. In step S620, the ultrasound ranging device may perform time calibration according to the light-source data. In step S630, according to barcode information corresponding to a processor of the ultrasound ranging device, the ultrasound ranging device may determine a time interval in which its ultrasound transmitter may transmit an ultrasonic signal. In step S640, when the ultrasound ranging device receives a control signal from a control device, the ultrasound ranging device may perform ultrasound ranging in the time interval.

According to an embodiment of the invention, the ultrasound ranging method further comprises the ultrasound ranging device performing a time calibration using the time packet comprised in the light-source data.

According to an embodiment of the invention, the ultrasound ranging method further comprises the processor of the ultrasound ranging device starting to count time after an ultrasound transmitter of the ultrasound ranging device transmits the ultrasonic signal. If the ultrasound receiver of the ultrasound ranging device does not receive the reflected signal within a default time (e.g. 5 ms), the ultrasound ranging device may restart to wait for a new control signal to be transmitted by the control device.

According to an embodiment of the invention, the ultrasound ranging method further comprises the reflected signal being enlarged by an operational amplifier after the processor of the ultrasound ranging device receives the reflected signal (which is transformed into a voltage signal by the ultrasound receiver) from the ultrasound receiver. Then, the voltage value of the enlarged signal may be compared with a threshold by a comparator to determine whether the voltage value of the enlarged signal is greater than the threshold. If the voltage value of the enlarged signal is greater than the threshold, the ultrasound ranging device may calculate distance based on the roundtrip time of the ultrasonic signal, and transmit a response signal about the distance to the control device. If the voltage value of the enlarged signal is not greater than the threshold, the ultrasound ranging device may restart to await a new control signal transmitted by the control device.

According to the ultrasound ranging method provided in the embodiments of the invention, when a plurality of electronic devices need to perform ultrasound ranging, each may do so during its corresponding time interval. Therefore, when a plurality of electronic devices need to perform ultrasound ranging, interference between the electronic devices can be avoided. In addition, according to the ultrasound ranging method provided in the embodiments of the invention, electronic devices may reduce their dependence on indoor positioning or satellite positioning.

Reference throughout this specification to “one embodiment” or “an embodiment” means that a particular feature, structure, or characteristic described in connection with the embodiment is included in at least one embodiment of the invention, but do not denote that they are present in every embodiment. Thus, the appearances of the phrases “in one embodiment” or “in an embodiment” in various places throughout this specification are not necessarily referring to the same embodiment of the invention.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. Alternatively, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An ultrasound ranging device, comprising:
an ultrasound transmitter, transmitting an ultrasonic signal;
an ultrasound receiver, receiving a reflected signal which is generated when the ultrasonic signal meets an obstacle;
a light sensor, receiving light-source data from an external light-source device; and
a processor, coupled to the light sensor to obtain the light-source data from the light sensor, performing a time calibration according to the light-source data, and after the time calibration, according to barcode information corresponding to the processor, determining a time interval in which the ultrasound transmitter transmits the ultrasonic signal.

2. The ultrasound ranging device of claim 1, wherein the processor receives a control signal from a control device to perform ultrasound ranging in the time interval.

3. The ultrasound ranging device of claim 2, wherein after the ultrasound transmitter transmits the ultrasonic signal, the processor starts to count time, and wherein if the ultrasound receiver does not receive the reflected signal within a default time, the processor restarts to await a new control signal transmitted by the control device.

4. The ultrasound ranging device of claim 3, wherein when the processor receives the reflected signal, the processor enlarges the reflected signal, and compares a voltage value of the enlarged signal with a threshold to determine whether the voltage value of the enlarged signal is greater than the threshold.

5. The ultrasound ranging device of claim 4, wherein if the voltage value of the enlarged signal is greater than the threshold, the processor calculates distance based on roundtrip time of the ultrasonic signal, and transmits a response signal about the distance to the control device; and wherein if the voltage value of the enlarged signal is not greater than the threshold, the processor restarts to await a new control signal transmitted by the control device.

6. The ultrasound ranging device of claim 1, wherein the light-source data comprises a time packet, and the processor performs the time calibration using the time packet.

7. An ultrasound ranging system, comprising:
an external light-source device, generating light-source data; and
a plurality of electronic devices, wherein each of the electronic devices comprises an ultrasound ranging device, and wherein each ultrasound ranging device comprises:
an ultrasound transmitter, transmitting an ultrasonic signal;
an ultrasound receiver, receiving a reflected signal which is generated when the ultrasonic signal meets an obstacle;
a light sensor, receiving the light-source data; and
a processor, coupled to the light sensor to obtain the light-source data from the light sensor, performing a time calibration according to the light-source data, and after the time calibration, according to barcode information corresponding to the processor, determining a time interval in which the ultrasound transmitter transmits the ultrasonic signal,
wherein each ultrasound ranging device of each electronic device corresponds to different barcode information and time intervals.

8. The ultrasound ranging system of claim 7, wherein each of the electronic devices further comprises:
a control device, coupled to the processor and generating a control signal to notify each ultrasound ranging device to perform ultrasound ranging.

9. The ultrasound ranging system of claim 8, wherein when the processor receives the control signal, the processor performs ultrasound ranging in the time interval.

10. An ultrasound ranging method, applied to an ultrasound ranging device, comprising:
receiving light-source data from an external light-source device;
performing time calibration according to the light-source data;
according to barcode information corresponding to a processor of the ultrasound ranging device, determining a time interval in which an ultrasound transmitter of the ultrasound ranging device transmits the ultrasonic signal; and
performing ultrasound ranging in the time interval when a control signal is received from a control device.
